(19) United States
(12) Patent Application Publication
(10) Pub. No.: US 2021/0078160 A1
(43) Pub. Date: Mar. 18, 2021

(54) MOUNTING MECHANISM AND ROBOT

(71) Applicant: SZ DJI TECHNOLOGY CO., LTD., Shenzhen (CN)

(72) Inventors: Xudong CHEN, Shenzhen (CN); Xiaobin YU, Shenzhen (CN); Xiaowei ZHENG, Shenzhen (CN)

(21) Appl. No.: 17/105,997

(22) Filed: Nov. 27, 2020

Related U.S. Application Data
(63) Continuation of application No. PCT/CN2018/106145, filed on Sep. 18, 2018.

(30) Foreign Application Priority Data
May 29, 2018 (CN) 201820818156.4

(51) Int. Cl. B25J 5/02; B25J 9/00; B25J 5/00

(52) U.S. Cl. CPC B25J 5/02; B25J 5/007; B25J 9/0027

(57) ABSTRACT

A mounting mechanism includes a base plate, a support arm, and a fixing frame. The support arm is mounted at the base plate. The fixing frame includes a connection end and a mounting end opposite to each other. The connection end is mounted at the support arm and configured to rotate relative to the support arm. The mounting end is configured to be selectively engaged with or separated from the base plate. The support arm is configured to be fixed relative to the base plate to clamp at a track when the mounting end is engaged with the base plate, and rotate relative to the base plate when the mounting end is separated from the base plate.

### CROSS-REFERENCE TO RELATED APPLICATIONS

This application is a continuation of International Application No. PCT/CN2018/106145, filed Sep. 18, 2018, which claims priority to Chinese Application No. 201820818156.4, filed May 29, 2018, the entire contents of both of which are incorporated herein by reference.

### TECHNICAL FIELD

The present disclosure generally relates to the robotic field and, more particularly, to a mounting mechanism and a robot.

### BACKGROUND

With the rapid development of intelligent technology and continuous update of the education concept, robotic technology, which is integrated with cutting-edge technologies of information technology, electronic engineering, mechanical engineering, control theory, sensor technology, and artificial intelligence, is used to benefit the revolution of the education. In some application scenarios, the robot may be mounted on a track for operation. For example, the robot may be mounted at a ring shape track, and the robot may operate automatically along the ring shape track. However, it is difficult to mount the robot of the existing technology at the ring shape track. Thus, the robot cannot be mounted at the ring shape track quickly.

### SUMMARY

Embodiments of the present disclosure provide a mounting mechanism includes a base plate, a support arm, and a fixing frame. The support arm is mounted at the base plate. The fixing frame includes a connection end and a mounting end opposite to each other. The connection end is mounted at the support arm and configured to rotate relative to the support arm. The mounting end is configured to be selectively engaged with or separated from the base plate. The support arm is configured to be fixed relative to the base plate to clamp at a track when the mounting end is engaged with the base plate, and rotate relative to the base plate when the mounting end is separated from the base plate.

Embodiments of the present disclosure provide a robot including a base and a mounting mechanism. The mounting mechanism is mounted at the base and includes a base plate, a support arm, a fixing frame. The support arm is mounted at the base plate. The fixing frame includes a connection end and a mounting end opposite to each other. The connection end is mounted at the support arm and configured to rotate relative to the support arm. The mounting end is configured to be selectively engaged with or separated from the base plate. The support arm is configured to be fixed relative to the base plate to clamp at a track when the mounting end is engaged with the base plate, and rotate relative to the base plate when the mounting end is separated from the base plate.

### BRIEF DESCRIPTION OF THE DRAWINGS

FIG. 1 is a schematic perspective structural diagram of a mounting mechanism according to some embodiments of the present disclosure.

FIG. 2 is a schematic exploded diagram of a robot according to some embodiments of the present disclosure.

FIG. 3 is a schematic diagram showing a mounting relationship among a base plate, a linkage assembly, an encoder, and a base of the robot according to some embodiments of the present disclosure.

FIG. 4 to FIG. 8 are schematic structural diagrams of the robot according to some embodiments of the present disclosure.

### DETAILED DESCRIPTION OF THE EMBODIMENTS

Embodiments of the present disclosure are described in detail. Embodiments of the present disclosure are shown in the accompanying drawings. The same or similar signs may represent the same or similar elements or elements having the same or similar functions. Embodiments described with reference to the accompanying drawings are exemplary, which are merely used to describe embodiments of the present disclosure and cannot be understood as limitations of the present disclosure.

In the description of embodiments of the present disclosure, the orientation or positional relationship indicated by the terms “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counterclockwise,” etc. is based on the orientation or positional relationship shown in the drawings, and is only for the convenience of describing embodiments of the present disclosure and simplifying the description, and does not indicate or imply that the device or element referred to must have a specific orientation or are structured and operated in the specific orientation. Therefore, the terms indicating the orientation or position relationship cannot be understood as limitations of embodiments of the present disclosure. In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include one or more of the features. In the description of embodiments of the present disclosure, “a plurality of” means two or more, unless otherwise specified.

In the description of embodiments of the present disclosure, unless otherwise specified and limited, the terms “mounting,” “connection,” and “coupling” should be understood in a broad sense, for example, it may be a fixed connection, a detachable connection, or an integral connection; it may be a mechanical connection or an electrical or communication connection; or it may be a direct connection or indirect connection through an intermediate medium, or it may be an internal communication of two components or an interaction relationship of the two components. For those of ordinary skill in the art, the specific meaning of the above-mentioned terms in embodiments of the present disclosure may be understood according to a specific situation.

In embodiments of the present disclosure, unless otherwise specified and defined, the first feature being “on” or “below” the second feature may include direct contact between the first and second features, or include that the first and second features are not in direct contact but through another feature between them. Moreover, the first feature being “on,” “above,” and “on top of” the second feature may include the first feature being directly above and obliquely above the second feature, or may only indicate that the horizontal level of the first feature is higher than the second feature. The first feature being “below,” “under,” and “beneath” the second feature may include the first feature being directly below and obliquely below the second feature, or only indicate that the horizontal level of the first feature is lower than the second feature.

The following disclosure provides many different embodiments or examples to realize different structures of embodiments of the present disclosure. To simplify the disclosure of embodiments of the present disclosure, the components and settings of a specific example are described below. The components and settings are only examples and are not intended to limit embodiments of the present disclosure. In addition, reference numbers and/or reference letters may be repeated in different examples of embodiments of the present disclosure. Such repetition is for the purpose of simplification and clarity and does not indicate the relationship between various embodiments and/or settings discussed. In addition, embodiments of the present disclosure provide examples of various specific processes and materials, but those of ordinary skill in the art may be aware of the application of other processes and/or the use of other materials.

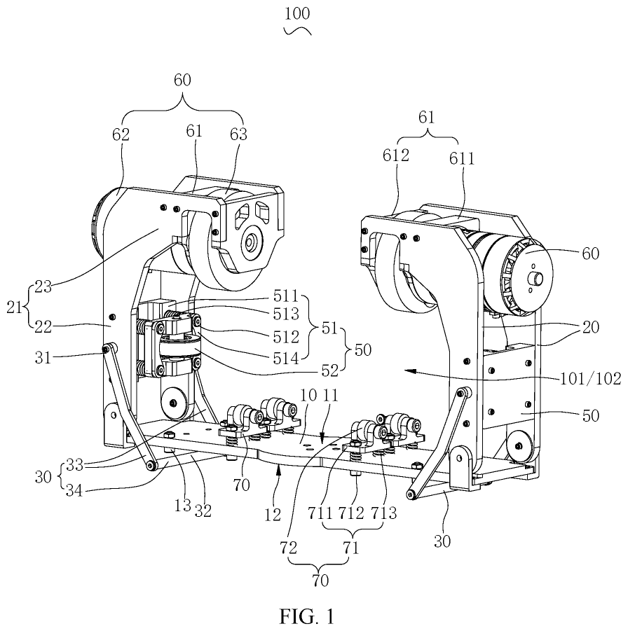

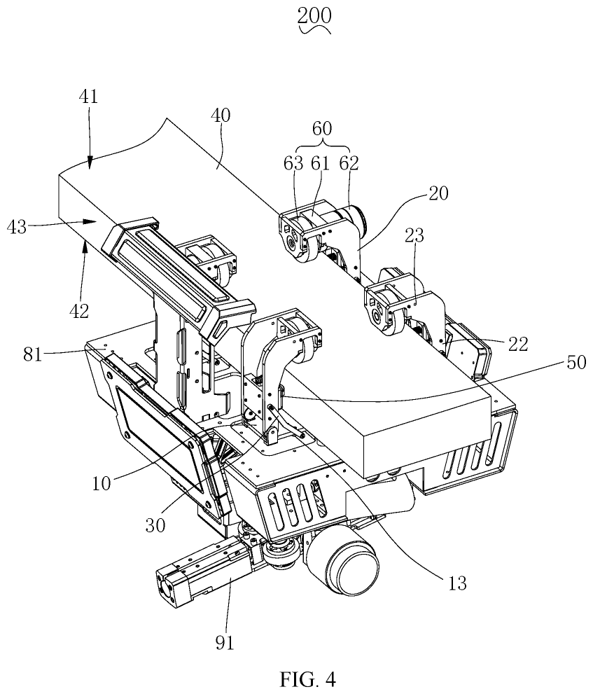

As shown in FIG. 1, a mounting mechanism 100 consistent with embodiments of the present disclosure includes a base plate 10, a support arm 20, and a fixing frame 30. The support arm 20 is mounted at the base plate 10 and may rotate relative to the base plate 10. The fixing frame 30 includes a connection end 31 and a mounting end 32 opposite to each other. The connection end 31 is mounted at the support arm 20 and may rotate relative to the support arm 20. The mounting end 32 may be selectively engaged with or separated from the base plate 10. When the mounting end 32 is engaged with the base plate 10, the support arm 20 is fixed relative to the base plate 10 to clamp at a track 40 (as shown in FIG. 4). When the mounting end 32 is separated from the base plate 10, the support arm 20 may rotate relative to the base plate 10.

In some embodiments, the mounting mechanism 100 may include one support arm 20. When the mounting end 32 is engaged with the base plate 10, the support arm 20 and the base plate 10 may enclose to form an accommodation space 101 to arrange the track 40 through. In some other embodiments, the mounting mechanism 100 may include two support arms 20. The two support arms 20 may be symmetrically arranged at two opposite ends of the base plate 10. The two support arms 20 and the base plate 10 may enclose to form an accommodation space 102 to arrange the track 40 through.

In some embodiments, the fixing frame 30 may be elastic. For example, the fixing frame 30 may be a spring or an elastic rod made of elastic material. In some other embodiments, the fixing frame 30 may be made of rigid material. For example, the fixing frame 30 may include an iron frame, an aluminum frame, or a carbon frame. The fixing frame 30 may be a rod. The two ends of the fixing frame 30 may be the connection end 31 and the mounting end 32, respectively. The fixing frame 30 may further include two parts, three parts, or more parts, which are connected to each other.

In some embodiments, the mounting end 32 may be engaged with the base plate 10 (e.g., an engaging member 13 arranged at the base plate 10) through a snap connection manner to fix the mounting end 32 at the base plate 10. In some other embodiments, the mounting end 32 may be connected to the base plate 10 by a connector to fix the mounting end 32 at the base plate 10. The connector may include a threaded rod, a screw, or a pin.

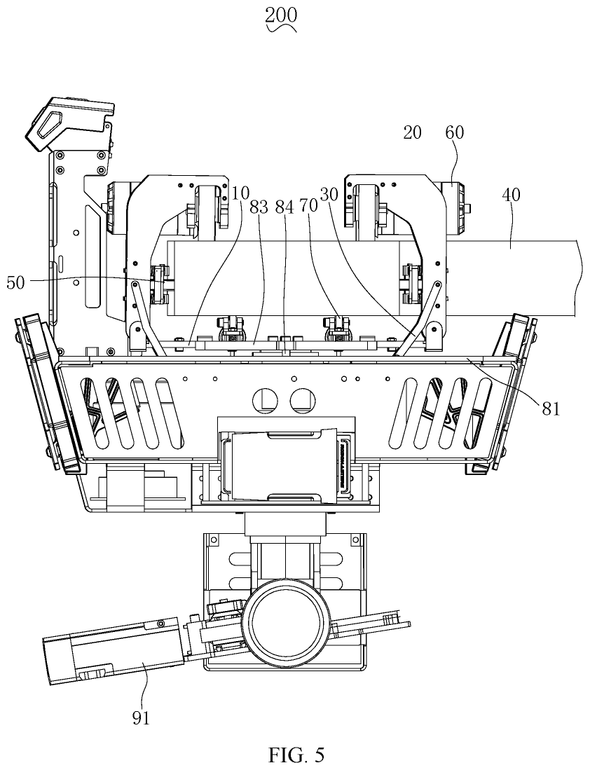

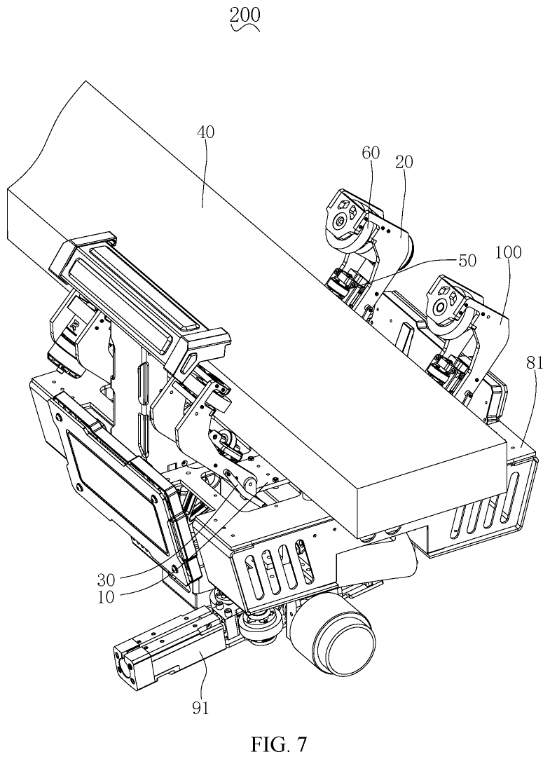

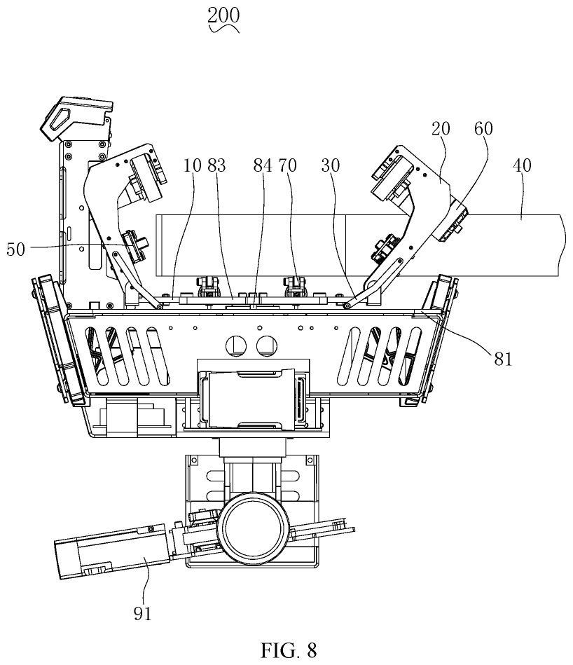

As shown in FIG. 4 and FIG. 7, when the mounting mechanism 100 is not mounted at the track 40, the mounting end 32 and the base plate 10 are usually in a separated state. First, a user arranges the mounting mechanism 100 at the track 40 (as shown in FIG. 7). Then, the user engages the mounting end 32 with the base plate 10 to mount the mounting mechanism at the track 40 (as shown in FIG. 4). As shown in FIG. 5 and FIG. 8, when the mounting mechanism 100 is mounted at the track 40 (as shown in FIG. 5), the user separates the mounting end 32 from the base plate 10 (as shown in FIG. 8) to detach the mounting mechanism 100 from the track 40.

In embodiments of the present disclosure, by arranging the fixing frame 30 at the support arm 20 and selectively engaging or separating the mounting end 32 with or from the base plate 10, the mounting mechanism 100 may be conveniently mounted at or detached from the track 40.

Referring again to FIG. 1, the mounting mechanism 100 includes the base plate 10, the engaging members 13, the support arms 20, the fixing frames 30, support arm guide assemblies 50, walking wheel assemblies 60, and base plate guide assemblies 70.

The base plate 10 may be a plate structure. The base plate 10 may include a base plate bottom surface 12 and a base plate top surface 11 opposite to each other. The engaging member 13 is arranged on a side of the base plate bottom surface 12 of the base plate 10. The engaging member 13 may include a snap hook or a protrusion extending from the base plate bottom surface 12 toward the side away from the base plate top surface 11. The engaging member 13 may also be a portion of the base plate 10. For example, the engaging member 13 may be a mounting hole provided at the base plate 10.

An end of the support arm 20 is mounted at the base plate 10 and may rotate relative to the bottom plate 10. The support arm 20 includes two support plates 21 arranged with an interval. The two support plates 21 may be fixed together by a support mounting frame connected to both support plates 21. The support mounting frame of embodiments of the present disclosure includes a support arm mounting base 511, a first mounting frame 611, and a second mounting frame 612. The support plate 21 includes a connection part 22 and a free part 23. The connection part 22 is obliquely connected to and forms an angle with the free part 23. The angle between the connection part 22 and the free part 23 may be an acute angle, an obtuse angle, or a right angle. In some embodiments, the angle between the connection part 22 and the free part 23 may be the right angle. The support plates 21 may be an integral structure or may be formed by connecting the connection part 22 and the free part 23 with a connecting piece. The connection part 22 is mounted at the base plate 10 and may rotate relative to the base plate 10. The mounting mechanism 100 may include one or more support arms 20. When the mounting mechanism 100 includes one support arm 20, the support arm 20 may be mounted at an end of the base plate 100. When the mounting mechanism 100 includes two support arms 20, two engaging members 13 are included, and the two support arms 20 may be mounted at two opposite ends of the base plate 10.

The fixing frame 30 is mounted at the support arm 20 and may rotate relative to the support arm 20. The fixing frame 30 includes two support frames 33 and a connection frame 34. The two support frames 33 both may be a “V” shape and elastic. The two support frames 33 are mounted at two opposite ends of the connection frame 34 and parallelly arranged. One end of each of the two support frames 33 away from the connection frame 34 is connected to one of the two support plates 21. The two ends of the two support frames 33 connected to the support plates 21 are the connection ends 31. Both support frames 33 are connected at outer sides (e.g., a side of any one of the two support plates 21 away from the other support plate 21) of the two support plates 21. The connection frame 34 may be selectively engaged with or separated from the engaging member 13. The connection frame 34 is the mounting end 32 of the fixing frame 30. When the mounting mechanism 100 includes one support arm 20 and the mounting end 32 is engaged with the base plate 10 (e.g., the connection frame 34 is engaged with the engaging member 13), the base plate 10, the connection part 22, and the free part 23 enclose to form the accommodation space 101. The track 40 (as shown in FIG. 4) is arranged through the accommodation space 101. If the mounting mechanism 100 includes two support arms 20, the mounting mechanism 100 includes two fixing frames 30 and two engaging members 13. When the two mounting ends 32 (e.g., the two fixing frames 30) engage with the base plate 10 (e.g., two connection frames 34 engage with two engaging members 13, respectively), the base plate 10 and the two support arms 20 may enclose to form the accommodation space 102. The track 40 is arranged through the accommodation space 102. A top surface 41 of the track 40 is opposite to the free part 23, and a bottom surface 42 of the track 40 is opposite to the base plate top surface 11. A side surface 43 of the track 40 is opposite to the connection part 22.

When the mounting mechanism 100 is arranged at the track 40, and the connection frame 34 is engaged with the engaging members 13, the base plate 10 abuts against the bottom surface 42 of the track 40, and the free part 23 abuts against the top surface 41 of the track 40. In this case, the support frame 33 may be extended (e.g., the support frame 33 may undergo an elastic deformation to cause a distance between the two ends of the support frame 33 to increase) and may generate an elastic force. The elastic force may provide a force for the connection frame 34 to be engaged with the engaging member 13, provide a force for the free part 23 to press the top surface 41 of the track 40 tightly and a force for the base plate 10 to press the bottom surface 42 of the track 40. As such, the support arm 20 and the base plate 10 both clamp tightly at the track 40 to fix the mounting mechanism 100 at the track 40. When the mounting mechanism 100 includes two support arms 20, the elastic force may further provide a force for the connection part 22 to press the side surface 43 of the track 40 tightly. In some embodiments, when the engaging member 13 is a snap hook, the connection frame 34 may be snapped to connect with the snap hook to fix the fixing frame 30 at the base plate 10. When the engaging member 13 is a protrusion formed by extending from the base plate bottom surface 12 toward the side away from the base plate top surface 11, the connection frame 34 may clamp at the protrusion by the elastic force to fix the fixing frame 30 at the base plate 10. In some other embodiments, the mounting mechanism 100 may include one support frame 33. In this case, an end of the connection frame 34 may be connected to the support frame 33, and the other end of the connection frame 34 may be a free end.

The support arm guide assembly 50 is mounted at the support arm 20. In some embodiments, the support arm guide assembly 50 is mounted at the connection part 22. When the mounting mechanism 100 is mounted at the track 40, the support arm guide assembly 50 abuts against the side surface of the track 40. The support arm guide assembly 50 may be a sliding structure (e.g., the sliding structure may include a sliding piece), which is fixed relative to the support arm 20. When the mounting mechanism 100 moves relative to the track 40, the support arm guide assembly 50 may slide relative to the track 40. In some other embodiments, the support arm guide assembly 50 may further include a rolling structure (e.g., the rolling structure may include a rolling wheel), which may rotate relative to the support arm 20. When the mounting mechanism 100 moves relative to the track 40, the rolling structure of the support arm guide assembly 50 may roll on the track 40.

In some embodiments, the support arm guide assembly 50 includes a support arm guide body 51 and a support arm guide wheel 52. The support arm guide wheel 52 is mounted at the support arm guide body 51 and may rotate relative to the support arm guide body 51. The support arm guide body 51 includes a support arm mounting base 511, a support arm guide member 512, a support arm guide base 513, and a support arm elastic member 514. In some other embodiments, the support arm guide body 51 may be an integral structure, or the support arm guide body 51 and the two support plates 21 may be an integral structure. In this case, the support arm guide assembly 51 may be a portion of the support arm 20.

The support arm mounting base 511 is mounted between the two support plates 21 by a fastener, or in other words, the two support plates 21 are mounted at two opposite sides of the support arm mounting base 511. As such, the two support plates 21 and the support arm mounting base 511 are fixed together. The support arm mounting base 511 includes an approximately rectangular block structure. In some embodiments, the support arm mounting base 511 is mounted between the two connectors 22. In some other embodiments, the support arm mounting base 511 may be a portion of the support arm 20. For example, the support arm mounting base 511 and the two support plates 21 may be an integral structure.

The support arm guide member 512 is mounted at the support arm mounting base 511. The support arm guide member 512 may be a cylindrical guide rod. The support arm guide member 512 is fixed at the support arm mounting base 511 by the fastener, or the support arm guide member 512 and the support arm mounting base 511 may be an integral structure. The mounting mechanism 100 may include one, two, three, four, or any number of support arm guide members 512. In some embodiments, the mounting mechanism 100 may include four support arm guide members 512. The four support arm guide members 512 are mounted at positions of the support arm mounting base 511 close to four corners and may be arranged in parallel.

The support arm guide base 513 is mounted at (e.g., arranged through) the support arm guide member 512 and may move (e.g., slide) relative to the support arm guide member 512. In some embodiments, a position-limiting member (not shown) may be arranged at an end of the support arm guide member 512 away from the support arm mounting base 511. The support arm guide base 513 may be arranged between the support arm mounting base 511 and the position-limiting member to prevent the support arm guide base 513 from detaching from the support arm guide member 512.

The support arm elastic member 514 is mounted between the support arm mounting base 511 and the support arm guide base 513 and is sleeved outside the support arm guide member 512. A number of the support arm elastic members 514 is the same as a number of the support arm guide members 512. The support arm elastic member 514 may always provide a force for the support arm guide base 513 to move toward the position-limiting member. The support arm elastic member 514 may be a spring.

The support arm guide wheel 52 is mounted at the support arm guide base 513 and may rotate relative to the support arm guide base 513. When the mounting mechanism 100 is mounted at the track 40, the support arm guide wheel 52 abuts against the side surface 43 of the track 40. When the mounting mechanism 100 moves relative to the track 40, the support arm guide wheel 52 may roll on the side surface of the track 40.

The walking wheel assembly 60 is mounted at the support arm 20. In some embodiments, the walking wheel assembly 60 is mounted at the free part 23. When the mounting mechanism 100 is mounted at the track 40, the walking wheel assembly 60 abuts against the top surface of the track 40. The walking wheel assembly 60 may be a sliding structure relative to the support arm 20. When the mounting mechanism 100 moves relative to the track 40, the walking wheel assembly may slide relative to the track 40. The walking wheel assembly 60 may further include a rolling structure, which may rotate relative to the support arm 20. When the mounting mechanism 100 moves relative to the track 40, the rolling structure of the walking wheel assembly 60 may roll on the track 40.

In some embodiments, the walking wheel assembly 60 includes a walking mounting frame 61, a drive motor 62, and a drive wheel 63. The walking mounting frame 61 is mounted between the two free parts 23, or in other words, the two free parts 23 are mounted at two opposite sides of the walking mounting frame 61 to fix the two free parts 23 and the walking mounting frame 61 together. The walking mounting frame 61 may include a multi-part structure. In some embodiments, the walking mounting frame 61 includes a first mounting frame 611 and a second mounting frame 612 arranged at an interval. Both of the first mounting frame 611 and the second mounting frame 612 are connected to the two free parts 23. The walking mounting frame 61 and the two support plates 21 may be an integral structure. In this case, the walking mounting frame 61 may be a portion of the structure of the support arm 20.

The drive motor 62 is mounted at a side of the first mounting frame 611 away from the second mounting frame 612. The drive wheel 63 is mounted between the first mounting frame 611 and the second mounting frame 612 and at a rotating shaft of the drive motor 62. The drive wheel 63 may rotate relative to the first mounting frame 611 and the second mounting frame 612. When the mounting mechanism 100 is mounted at the track 40, the drive wheel 63 abuts against the top surface 41 of the track 40. When the drive motor 62 drives the drive wheel 63 to rotate, the drive wheel 63 may roll relative to the top surface 41 of the track 40 to drive the mounting mechanism 100 to move on the track 40.

The base plate guide assembly 70 is mounted at the base plate 10. In some embodiments, the base plate guide assembly 70 is mounted at the base plate top surface 11. When the mounting mechanism 100 is mounted at the track 40, the base plate guide assembly 70 abuts against the bottom surface 42 of the track 40. The base plate guide assembly 70 may include a sliding structure fixed relative to the base plate 10. When the mounting mechanism 100 moves relative to the track 40, the base plate guide assembly 70 may slide relative to the tack 40. The base plate guide assembly 70 may further include a rolling structure, which may rotate relative to the base plate 10. When the mounting mechanism 100 moves relative to the track 40, the rolling structure of the base plate guide assembly 70 may roll on the track 40.

The base plate guide assembly 70 of embodiments of the present disclosure includes a base plate guide body 70 and a base plate guide wheel 72. The base plate guide wheel 72 is mounted at the base plate guide body 71 and may rotate relative to the base plate guide body 71. The base plate guide body 71 includes a base plate guide base 711, a base plate guide member 712, and a base plate elastic member 713. In some other embodiments, the base plate guide body 71 may be an integral structure or the base plate guide body 71 may be a portion of the base plate 10.

In some embodiments, the base plate guide member 712 is mounted at the base plate 10. The base plate guide member 712 may be a cylindrical guide rod. The base plate guide member 712 is fixed at the base plate 10 by a fastener. In some other embodiments, the base plate guide member 712 and the base plate 10 may be an integral structure. The mounting mechanism 100 may include one, two, three, four, or any number of base plate guide members 712. In some embodiments, the mounting mechanism 100 may include two base plate guide members 712.

The base plate guide base 711 is mounted at the base plate guide members 712 and may move relative to the base plate guide members 712. In some embodiments, the two base plate guide members 712 are located at two opposite ends of the base plate guide base 711. A position-limiting member (not shown) may be arranged at an end of the base plate guide member 712 away from the base plate 10. The base plate guide base 711 may be arranged between the base plate 10 and the position-limiting member to prevent the base plate guide base 711 from detaching from the base plate guide members 712.

The base plate elastic members 713 are mounted between the base plate 10 and the base plate guide base 711 and are sleeved outside the base plate guide members 712. A number of the base plate elastic members 713 is the same as a number of the base plate guide members 712. The base plate elastic members 713 may always provide a force for the base plate guide base 711 to move toward the position-limiting member. The base plate elastic member 713 may be a spring.

The base plate guide wheel 72 is mounted at the base plate guide base 711 and may rotate relative to the base plate guide base 711. When the support arm 20 is configured to clamp at the track 40, the base plate guide wheel 72 is configured to abut against the bottom surface 42 of the track 40 and may rotate relative to the bottom surface of the track 40.

In embodiments of the present disclosure, by arranging the fixing frame 30 at the support arm 20 and selectively engaging or separating the mounting end 32 with or from the base plate 10, the mounting mechanism 100 may be conveniently mounted at or detached from the track 40.

Further, by arranging the engaging member 13 at the base plate 10, the fixing frame 30 may be engaged with the base plate 10 by the engaging member 13. The support frame 33 of the fixing frame 30 may be elastic, such that the fixing frame 30 may be conveniently engaged with the engaging member 13 by the elastic force. By arranging the support arm guide assembly 50 at the mounting mechanism 100, when the mounting mechanism 100 slides on the track 40, the support guide assembly 50 may guide the mounting mechanism 100 to facilitate the mounting mechanism 100 to move on the track 40. By arranging the support arm elastic member 514 at the support guide assembly 50, the support arm guide wheel 52 tightly clamps at the track 40 with the function of the support arm elastic member 514. By arranging the walking wheel assembly 60 at the mounting mechanism 100, when the mounting mechanism 100 slides on the track 40, the walking wheel assembly 60 may guide the mounting mechanism 100 to facilitate the mounting mechanism 100 to move on the track 40. The walking wheel assembly 60 includes the drive motor 62 and the drive wheel 63. When the drive motor 62 drives the drive wheel 63 to rotate, the walking wheel assembly 60 may drive the mounting mechanism 100 to slide on the track 40. The base plate guide assembly 70 may guide the mounting mechanism 100 to facilitate the mounting mechanism 100 to move on the track 40. By arranging the base plate elastic member 713 at the base plate guide assembly 70, the base plate guide wheel 72 tightly clamps at the track 40 with the function of the base plate elastic member 713.

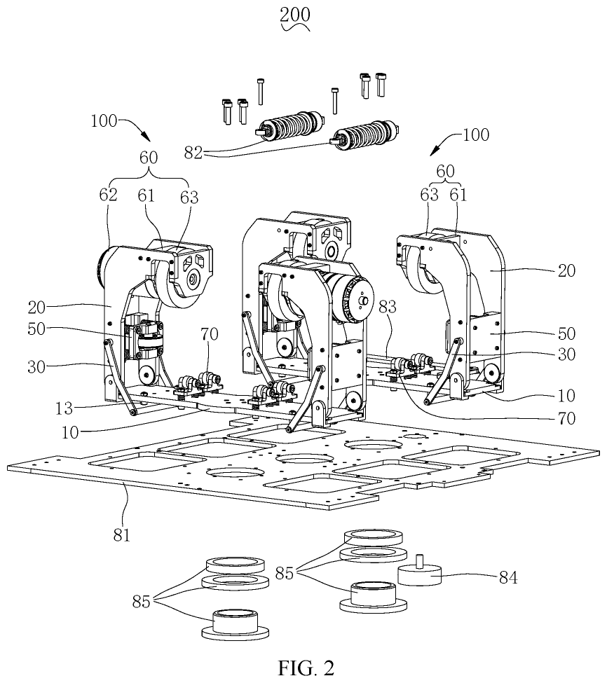

Referring to FIG. 2, a robot 200 of embodiments of the present disclosure includes a base 81 and the mounting mechanism 100 of any above embodiments. The mounting mechanism 100 is mounted at the base 81.

In some embodiments, the mounting mechanism 100 is mounted at the base 81 and may rotate relative to the base 81. The robot 200 may include one, two, three, or any number of mounting mechanisms 100. When the robot 200 includes two, three, or any number of mounting mechanisms 100, the mounting mechanisms 100 are arranged in parallel at intervals. In some other embodiments, the mounting mechanisms 100 may be fixed at the base 81. In this case, the mounting mechanisms 100 may not rotate relative to the base 81.

In embodiments of the present disclosure, by arranging the fixing frame 30 at the support arm 20 of the mounting mechanism 100 of the robot 200, and selectively engaging or separating the mounting end 32 with or from the base plate 10, the robot 200 may be conveniently mounted at or detached from the track 40.

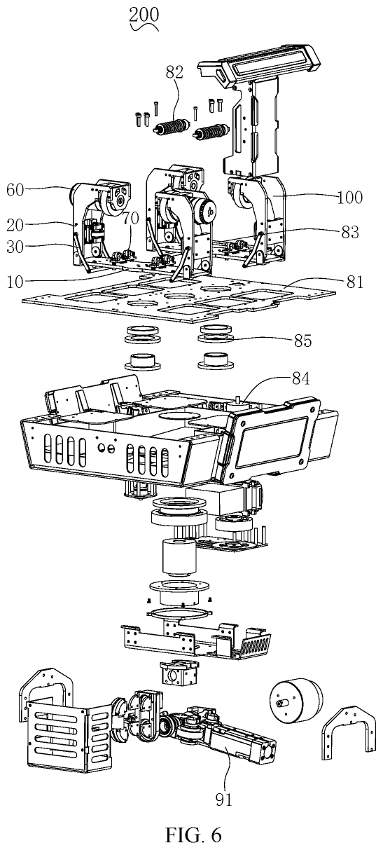

As shown in FIG. 2 and FIG. 6, the robot 200 of embodiments of the present disclosure includes the base 81, the mounting mechanism 100, a shock-absorbing member 82, a linkage assembly 83, and an encoder 84.

In some embodiments, the robot 200 includes two mounting mechanisms 100. The two mounting mechanisms 100 are parallelly arranged at the base 81 and may rotate relative to the base 81. A rotation center of the mounting mechanism 100 is located at (or through) a center position of the base plate 10. In some embodiments, the mounting mechanism 100 is mounted at the base 81 by a bearing assembly 85. The bearing assembly 85 may include a thrust bearing and a radial bearing. The walking wheel assembly 60 of one of the mounting mechanisms 100 is arranged with the drive motor 62 and the drive wheel 63. The walking wheel of the other one of the mounting mechanisms 100 is arranged with the drive wheel 63 but not the drive motor 62. The mounting mechanism 100 with the drive motor 62 may provide power for the robot 200. The mounting mechanism 100 without the drive motor 62 tightly clamps at the track 40 and provides a guidance function.

Two ends of the shock-absorbing member 82 are mounted at the base 81 and the base plate 10, respectively. The shock-absorbing member 82 may rotate relative to the base 81 and the base plate 10. The shock-absorbing member 82 may be elastic and may be extended or compressed. The shock-absorbing member 82 may be a spring. The robot 200 includes two shock-absorbing members 82. At an initial position (a position that the shock-absorbing member is not extended or compressed), the two shock-absorbing members 82 are parallelly arranged, and the two shock-absorbing members 82 are mounted at the base plate 10 symmetrically about the center position of the base plate 10. The shock-absorbing members 82 may provide forces for the base plate 10 to return (e.g., rotate) to the initial position to reduce the vibration generated when the mounting mechanism 100 moves relative to the track 40. In some other embodiments, the robot may include one shock-absorbing member 82.

The encoder 84 is mounted at the base 81.

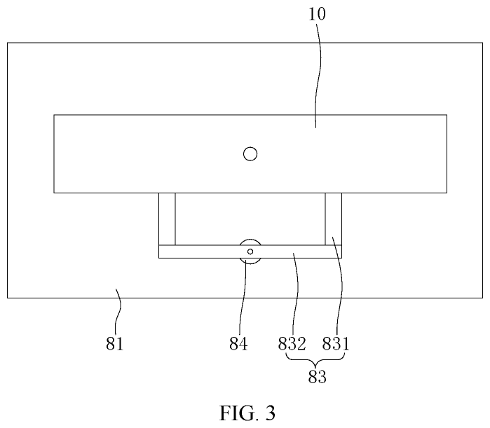

As shown in FIG. 3, the linkage assembly 83 is mounted at the base plate 10 and connected to the encoder 84. The linkage assembly 83 includes two connection rods 831 and a mounting rod 832. The mounting rod 832 is arranged in parallel to the base plate 10. The two connection rods 831 are arranged in parallel to each other. One end of each of the two connection rods 831 is mounted at one of two opposite ends of the mounting rod 832, and the two connection rods 831 may rotate relative to the mounting rod 832. The other end of each of the two connection rods 831 is mounted at the base plate 10, and the two connection rods 831 may rotate relative to the base plate 10. The two connection rods 831 are mounted at the base plate 10 symmetrically about the center position of the base plate 10. The encoder 84 is connected to the center position of the mounting rod 832. When the base plate 10 rotates relative to the base 81, the two connection rods 831 may drive the mounting rod 832 to rotate around the center position (e.g., encoder 84) of the mounting rod 832. As such, the rotation direction and size of the mounting rod 832 may be consistent with the rotation direction and size of the base plate 10.

Referring to FIG. 3, the encoder 84 is configured to detect an angle that the mounting rod 832 (or the base plate 10) rotates relative to the base 81. The encoder 84 is further configured to determine whether the mounting mechanism 100 passes through the curve of the track 40 according to the angle and control a speed of the mounting mechanism 100 moving along the track 40 when the mounting mechanism 100 passes through the curve. Those skilled in the art may set how according to the actual situation the encoder 84 may control the speed of the mounting mechanism 100 moving along the curve of the track 40 according to the detected angle. For example, after detecting the angle of the mounting rod 832 moving relative to the base 81, the encoder 84 may directly control the mounting mechanism 100 to slow down to pass through the curve slowly to prevent the mounting mechanism 100 from detaching from the track 40 and improve safety. For another example, if the mounting mechanism 100 includes two support arms 20 and two walking wheel assemblies 60 (e.g., the walking wheel assembly 60 may include a drive motor 62) mounted at the two support arms 20, the encoder 84 may control the walking wheel assembly 60 located on an inner side of the track 40 to slow down and control the walking wheel assembly 60 located on an outer side of the track 40 to speed up according to the detected angle of the mounting rod 832. As such, the mounting mechanism 100 may pass through the curve faster and may not detach from the track 40.

In embodiments of the present disclosure, by arranging the fixing frame 30 at the support arm 20 of the mounting mechanism 100 of the robot 200, and selectively engaging or separating the mounting end 32 with or from the base plate 10, the robot 200 may be conveniently mounted at or detached from the track 40. Further, the robot 200 includes two mounting mechanisms 100. Thus, the robot 200 may be steadily mounted at the track 40 and may slide more steadily relative to the track 40. The robot 200 may reduce the vibration generated when the mounting mechanism 100 moves relative to the track 40 by arranging the shock-absorbing member 82. By arranging the linkage assembly 83 and the encoder 84, the robot 200 may control the speed of the mounting mechanism 100 moving along the track 40 when passing through the curve by the encoder 84.

In some other embodiments, both walking wheel assemblies 60 of the mounting mechanisms 100 may be arranged with the drive motors 62 and the drive wheels 63. The robot 200 may have a great ability to pass the curve when the robot 200 moves in a positive direction and in a reverse direction on the track 40.

As shown in FIG. 4 to FIG. 8, in some embodiments, the robot 200 further includes a camera device 91 mounted at the base 81.

In the description of the present disclosure, the description of the reference terms “certain embodiments,” “one embodiment,” “some embodiments,” “exemplary embodiments,” “examples,” “specific examples,” or “some examples,” etc., means that specific features, structures, materials, or characteristics described in combination with embodiments or examples are included in at least one embodiment or example of the present disclosure. In this specification, the schematic representations of the above terms do not necessarily refer to the same embodiment or example. Moreover, the described specific features, structures, materials, or characteristics may be combined in an appropriate manner in any one or more embodiments or examples.

In addition, the terms “first” and “second” are only used for a descriptive purpose, and cannot be understood as indicating or implying relative importance or implicitly indicating the number of indicated technical features. Therefore, the features defined with “first” and “second” may explicitly or implicitly include at least one of the features. In the description of embodiments of the present disclosure, “a plurality of” means at least two, for example, two, three, etc., unless specifically defined otherwise.

Although embodiments of the present disclosure have been shown and described above, the above embodiments are exemplary and should not be understood as a limitation of the present disclosure. Those of ordinary skill in the art may perform variations, changes, substitutions, and modifications on embodiments within scope of the present disclosure. The scope of the present invention is defined by the claims and their equivalents.

What is claimed is:

1. A mounting mechanism comprising:
a base plate;
a support arm mounted at the base plate; and
a fixing frame including a connection end and a mounting end opposite to each other, the connection end being mounted at the support arm and configured to rotate relative to the support arm, and the mounting end being configured to be selectively engaged with or separated from the base plate;
wherein the support arm is configured to:
be fixed relative to the base plate to clamp at a track when the mounting end is engaged with the base plate; and
rotate relative to the base plate when the mounting end is separated from the base plate.

2. The mounting mechanism of claim 1, wherein the fixing frame includes:
a connection frame as the mounting end and configured to be selectively engaged with or separated from the base plate; and
a support frame, an end of the support frame being connected to the connection frame, and another end of the support frame away from the connection frame being mounted at the support arm and being the connection end.

3. The mounting mechanism of claim 2, further comprising:
an engaging member arranged at the base plate and including:
a snap hook, the connection frame being snapped to the snap hook to fix the fixing frame at the base plate; or
a protrusion extending from the base plate outward, the connection frame being engaged with the protrusion to fix the fixing frame at the base plate.

4. The mounting mechanism of claim 2, wherein:
the support frame is one of two support frames mounted at the base plate; and
the two support frames are parallelly arranged and connected to two sides of the connection frame.

5. The mounting mechanism of claim 2, wherein:
the support frame has a “V” shape and is elastic; and
the support frame is configured to, when the mounting mechanism is mounted at the track and the connection frame is engaged with the base plate, undergo an elastic deformation to increase a distance between two ends of the support frame, and cause the support arm to clamp at the track with an elastic force generated by the elastic deformation.

6. The mounting mechanism of claim 1, further comprising:
a support arm guide assembly mounted at the support arm and configured to abut against a side surface of the track when the support arm clamps at the track.

7. The mounting mechanism of claim 6, wherein the support arm guide assembly includes:
a support arm guide body; and
a support arm guide wheel mounted at the support arm guide body and configured to rotate relative to the support arm guide body, the support arm guide wheel being further configured to abut against the side surface of the track and roll relative to the side surface of the track when the support arm clamps at the track.

8. The mounting mechanism of claim 7, wherein the support arm guide body includes:
a support arm mounting base mounted at a side of the support arm;
a support arm guide member mounted at the support arm mounting base;
a support arm guide base mounted at the support arm guide member and configured to move relative to the support arm guide member, the support arm guide wheel being mounted at the support arm mounting base and configured to rotate relative to the support arm guide base; and
a support arm elastic member mounted between the support arm mounting base and the support arm guide base.

9. The mounting mechanism of claim 1, wherein:
the support arm includes:
a connection part mounted at the base plate and configured to rotate relative to the base plate; and
a free part connected to the connection part; and
when the mounting end is engaged with the base plate, the base plate, the connection part, and the free part enclose to form an accommodation space for accommodating the track.

10. The mounting mechanism of claim 9, further comprising:
a walking wheel assembly mounted at the free part opposite to the base plate and configured to abut against a top surface of the track when the mounting end is engaged with the base plate.

11. The mounting mechanism of claim 10, wherein the walking wheel assembly includes:
a drive motor mounted at the free part; and
a drive wheel mounted at the drive motor and configured to drive the mounting mechanism to move on the track when the drive motor drives the drive wheel to rotate.

12. The mounting mechanism of claim 9, wherein:
the support arm is one of two support arms mounted at two opposite ends of the base plate, respectively;
the fixing frame is one of two fixing frames mounted at the two support arms, respectively; and
when the two fixing frames are engaged with the base plate, the base plate and the two support arms enclose to form an accommodation space for accommodating the track.

13. The mounting mechanism of claim 1, further comprising:
a base plate guide assembly mounted at the base plate and configured to abut against a bottom surface of the track when the mounting end is engaged with the base plate.

14. The mounting mechanism of claim 13, wherein the base plate guide assembly includes:
a base plate guide body; and
a base plate guide wheel mounted at the base plate guide body and configured to rotate relative to the base plate guide body, the base plate guide wheel being configured to abut against the bottom surface of the track and roll relative to the bottom surface of the track when the support arm clamps at the track.

15. The mounting mechanism of claim 14, wherein the base plate guide body includes:
a base plate guide member mounted at the base plate;
a base plate guide base mounted at the base plate guide member and configured to move relative to the base plate guide member, the base plate guide wheel being mounted at the base plate guide base and configured to rotate relative to the base plate guide base; and
a base plate elastic member mounted between the base plate and the base plate guide base.

16. A robot comprising:
a base; and
a mounting mechanism mounted at the base and including:
a base plate;
a support arm mounted at the base plate; and
a fixing frame including a connection end and a mounting end opposite to each other, the connection end being mounted at the support arm and configured to rotate relative to the support arm, and the mounting end being configured to be selectively engaged with or separated from the base plate;
wherein the support arm is configured to:
be fixed relative to the base plate to clamp at a track when the mounting end is engaged with the base plate; and
rotate relative to the base plate when the mounting end is separated from the base plate.

17. The robot of claim 16, wherein the fixing frame includes:
a connection frame as the mounting end and configured to be selectively engaged with or separated from the base plate; and
a support frame, an end of the support frame being connected to the connection frame, and another end of the support frame away from the connection frame being mounted at the support arm and being the connection end.

18. The robot of claim 16, wherein the mounting mechanism further includes:
a support art guide assembly mounted at the support arm and configured to abut against a side surface of the track when the support arm clamps at the track.

19. The robot of claim 16, wherein:
the support arm includes:
a connection part mounted at the base plate and configured to rotate relative to the base plate; and
a free part connected to the connection part; and
when the mounting end is engaged with the base plate, the base plate, the connection part, and the free part enclose to form an accommodation space for accommodating the track.

20. The robot of claim 16, wherein the mounting mechanism further includes:
a base plate guide assembly mounted at the base plate and configured to abut against a bottom surface of the track when the mounting end is engaged with the base plate.
